(19) United States
(12) Patent Application Publication
(10) Pub. No.: US 2005/0275595 A1
(43) Pub. Date: Dec. 15, 2005

(54) Planar broadband inverted F-type antenna and information terminal

(75) Inventors: Shuichi Endo, Yokohama-shi (JP); Kanazu Taniguchi, Tokyo (JP); Katsuhisa Aida, Tokyo (JP); Ken Nema, Okinawa (JP)

Correspondence Address: GEORGE A. LOUD, 625 SLATERS LANE, FOURTH FLOOR, ALEXANDRIA, VA, 22314, US

(73) Assignees: IIDA CO., LTD., Tokyo (JP); ALLIANCE CO., LTD., Okinawa (JP)

(21) Appl. No.: 11/149,528

(22) Filed: Jun. 10, 2005

(30) Foreign Application Priority Data
Jun. 15, 2004 (JP) 2004-176962

(51) Int. Cl. H01Q 1/24

(52) U.S. Cl. 343/702

(57) ABSTRACT

A planar broadband inverted F-type antenna has a pattern formed by etching a conductive foil laminated on the obverse side and the reverse side of the PET film 113. The antenna is applicable to the 5.0 GHz frequency band. The ground 107, the antenna element 101, and the connection element 105 are formed on the obverse side. The ground has the ground point connectable to the ground line of the feeding wire. The antenna element has a plurality of emission patterns adaptable to the 5.0 GHz frequency band. Each pattern has the length varying from each other. The connection element connects each emission pattern to the ground. The feeding pattern 183, which is formed on the reverse side, has the feeding terminal 181 connectable to the voltage line of the feeding wire. The feeding pattern is connected to the connection element. The feeding pattern includes a parallel wiring component to the emission patterns. The feeding pattern is positioned to overlap the vertical projection with at least one of the emission patterns so that the phase adjustment is provided to decrease the voltage standing wave ratio.

### FIELD OF THE INVENTION

The present invention relates to a planar broadband inverted F-type antenna suitable to a broad bandwidth, and more particularly relates to the planar broadband inverted F-type antenna manufactured by etching an flexible printed circuit (FPC) and suitable to the broad bandwidth.

### BACKGROUND OF THE INVENTION

Installation of a wireless LAN system in a mobile information terminal such as a notebook type personal computer or PDA (Personal Digital Assistant) is increasing in accordance with development of lightweight structure and miniaturization. A standard for two frequency bands of the wireless LAN system is now established for a 2.4 GHz band (IEEE802.11b/g) and a 5.0 GHz band (IEEE802.11a) under a working group of IEEE (the Institute of Electrical and Electronic Engineers). Accordingly, the antenna capable of being used in these two frequency bands is required from the information terminal equipped with the wireless LAN system. A planate antenna or a flat shape antenna is used in the information terminal in view of durability, low price, lightweight, and compact shape. The inverted F-type antenna is adopted chiefly in the information terminal, because of non-directivity and easily miniaturized feature.

The inverted F-type antenna is disclosed in the Japanese published unexamined patent applications JP-A-11-41026, where a powerless feeding conductor panel is provided in addition to an emission conductive panel to achieve broad bandwidth. An antenna unit is disclosed in the Japanese published unexamined patent applications JP-A-2003-78320, which is formed on an insulating layer of a FPC. A film antenna is disclosed in the “Hitachi Cable” No. 21 (2002-1) entitled “Development of 2.4 GHz Film Type Antenna for Mobile Devices”, where a emission element and a narrow slit are formed on a flat metal panel to realize a structure of the inverted F-type antenna.

### SUMMARY OF THE INVENTION

A conventional inverted F-type antenna, as shown in FIG. 1, was constituted by two elements 11, 13 having lengths of differing from each other and being disposed in parallel with each other to be adapted to a use of a dual-band such as the 2.4 GHz band and the 5.0 GHz band. However the conventional antenna could not provide the sufficient bandwidth for the 5.0 GHz band especially. The bandwidth means an allowed frequency range specified in the standard per use, allowing the information terminal to establish a communication channel at the frequency within the range.

For example, a 975 MHz bandwidth for the 5.0 GHz band specified in the IEEE standard as the frequency range of 4.900 GHz-5.875 GHz is used, and a 74 MHz bandwidth for the 2.4 GHz band also specified in the IEEE standard as the frequency range of 2.412 GHz-2.486 GHz is used. While each country prescribes independent frequency channels selected from the band to allow people to use in the country. For instance, a lower band (A central frequency is 5.13 GHz-5.24 GHz) for four channels is allowed in Japan in the 5.0 GHz band, besides a middle band (A central frequency is 5.25 GHz-5.43 GHz) and an upper band (A central frequency is 5.5 GHz-5.825 GHz) are allowed in the United States of America and in Europe.

It is preferable for the antenna used for the wireless LAN system installed in the mobile information terminal carried in crossing a boarder to be adaptable to a full frequency range of each bandwidth specified in the IEEE standard, because a transmitter of the wireless LAN system establishes communication by automatically choosing an available channel from the allowed frequency channels in the country. A voltage standing wave ration (referred as VSWR hereafter) is adopted as an evaluation index to a performance of the antenna. The VSWR is defined as a ratio between a crest and a trough of a voltage amplitude distribution existing in a feeding wire, where an impedance matching between an antenna element and the feeding wire is not achieved. An ideal condition without a reflection from the antenna gives the impedance matching and brings the VSWR to 1.0. It is preferable for the antenna for use in the wireless LAN system that the VSWR is as small as possible. Generally speaking, the VSWR of 2.0 or less allows the antenna to perform stable characteristics under various circumstances.

The antenna 10 with a structure shown in FIG. 1(A) is composed of the short element 11 for the 5.0 GHz band, the long element 13 for the 2.4 GHz band, and an electrical ground 15. The antenna 10 could no provide a sufficient delta F corresponding to the bandwidth to make the VSWR 2.0 or less in the 5.0 GHz band as shown in FIG. 1(B), providing only one element for every frequency band. Accordingly, a countermeasure such as providing plural antennas resonating at various frequencies was necessary to expand the bandwidth.

Therefore, it is an object of the present invention to provide the small, thin, and lightweight planar broadband inverted F-type antenna. It is another object of the present invention to provide the planar broadband inverted F-type antenna realized by means of etching the FPC. It is a further object of the present invention to provide the planar broadband inverted F-type antenna adaptable to the bandwidth specified in the IEEE standard. It is a further object of the present invention to provide the planar broadband inverted F-type antenna enabled to obtain the stable characteristics in the mass-production process.

In order to achieve these objects, one aspect of the present invention provides the planar broadband inverted F-type antenna which has a conductive layer pattern formed on a surface of a dielectric layer, being used for a 5.0 GHz band and a 2.4 GHz band, and being connectable with a feeding wire. The conductive layer pattern comprises; an electrical ground having a ground point connectable to a ground line of the feeding wire, and being formed on an obverse side of the dielectric layer; a first element having emission patterns between six or more and nine or less, each pattern being adaptable to the 5.0 GHz band, each pattern having a length differing from each other, and said first element being formed on the obverse side of the dielectric layer; a second element having a feeding point connectable to a voltage line of the feeding wire, connecting each emission pattern of said first element to said electrical ground, and being formed on the obverse side of the dielectric layer; a third element having an emission pattern adaptable to the 2.4 GHz band at lambda/4 (where lambda is a wavelength), being connected to said second element, and being formed on the obverse side of the dielectric layer; and a feeding pattern having a feeding terminal, being connected to the feeding point of said second element, and being formed on a reverse side of the dielectric layer. Said feeding pattern includes a parallel wiring component to the emission patterns of said first element, said feeding pattern is positioned to overlap a vertical projection with at least one of the emission patterns of said first element so that a phase adjustment is provided to decrease a voltage standing wave ratio.

The conductive layer pattern is formed on the surface of the dielectric layer in the antenna. The plurality of emission patterns can be precisely formed by means of a well known technology such as a chemical vapor deposition (CVD) or a photo-lithography which are applied to a semi-conductive manufacturing process. Moreover such technology can be applied to the FPC which consists of a base film and a conductive foil laminated thereon to manufacture the antenna. The first element connects with the second element and the second element connects with the electrical ground. The planar broadband inverted F-type antenna is constituted, connecting the voltage line and the ground line of the feeding wire to the second element and the electrical ground respectively.

The first element includes the plurality of emission patterns with lengths of differing from each other, and the length of each emission pattern is enabled to resonate at any one of the frequencies in the first frequency band. Therefore every emission pattern decreases the VSWR of the first frequency band. The emission patterns correspond to a long and narrow electrode formed by processing the conductive layer laminated on the dielectric layer. Every emission pattern resonates at various frequencies in the first frequency band respectively to decrease the VSWR, the length of each pattern varying from each other.

Having six or more emission patterns is preferable for the antenna of the present invention to obtain the practically broad bandwidth. Each emission pattern is brought to take its share to decrease the VSWR in an effective balance within the first frequency band, constituting the length of each emission pattern to vary by a same length in sequence from the longest pattern to the shortest pattern. The first element used for the 5.0 GHz band can achieve outstanding characteristics by choosing the number of the emission patterns between six or more and nine or less.

An antenna in use for a multi-bandwidth can be constituted in a combination of a chip-antenna and the antenna consisting of the first element and the second element. The chip-antenna is a mono-pole antenna made from a high dielectric constant materials, and the combination being able to constitute the antenna adaptable to a second frequency band higher than the first frequency band without a limitation in size, because it has a peculiarity enabling a use of a shorter element compared to the inverted F-type antenna at the same frequency. Moreover such multi-band antenna can be manufactured easily.

An adoption of a fine process to form the emission patterns makes the planar broadband inverted F-type antenna suitable to the miniaturization. Though the highly efficient high-frequency antenna can be realized through the fine process, a connection of the voltage line of the feeding wire slightly deviated from a best location in the feeding point prevents from obtaining the satisfactory VSWR and the connection requires an accurate positioning of the feeding wire. Particularly, technologies for the accurate positioning and the connection of the feeding wire are required in the mass-production of the antenna. From this point of view, the antenna, provided with the feeding pattern extending from the second element which works as an extension of the voltage line of the feeding wire, can realize the stable VSWR in the mass-production, because the feeding pattern can be positioned and connected to the feeding point of the second element through the process of the pattern formation.

Provided with a lengthened pattern connected to the plurality of the emission patterns of the first element to make the length of the first element longer substantially, the antenna can shift an adaptable frequency band from one under no lengthened pattern to a lower band. Forming the emission pattern at the reverse side of the dielectric layer is preferable to form longer lengthened pattern by taking advantage of sufficient space for the pattern formation thereon. Having the plurality of emission patterns adaptable to the 5.0 GHz band and the plurality of emission patterns adaptable to the 2.4 GHz band in the conductive layer, the antenna can achieve the broad frequency bandwidth in both frequency bands.

The planar broadband inverted F-type antenna can be manufactured through the etching process to the FPC made of a base file and a conductive foil in advance. The FPC is suitable to manufacturing the antenna related to the present invention, allowing a fine pattern to be formed by means of the etching process thereto without an introduction of a complicated semiconductor process. A formation of the etched pattern at the reverse side of the base film enables to take advantage of a space in the conductive foil effectively, or to obtain the stable antenna characteristics. A silver through-hole can be formed to connect the conductive layer at the obverse side and the reverse side of the base film. Forming a copper through-hole in the FPC is not suitable, because materials of the FPC are vulnerable to a chemical treatment or a thermal treatment used in the etching process. The silver through-hole screen-stenciled, which does not include the chemical treatment or the thermal treatment to deteriorate the FPC, is suitable for connecting the pattern at the obverse side and at the reverse side of the base film.

Forming the feeding pattern in the conductive foil on the reverse side and to connect one end of the feeding pattern to the feeding point of the second element on the obverse side through the silver through-hole is preferable, because such a constitution enables to select the feeding point at the obverse side or the reverse side in accordance with a position of the antenna installed. The voltage line of the feeding wire is connected to the other end of the feeding pattern and the ground line of the feeding wire is connected to the electrical ground through another silver through-hole to feed from the reverse side. The feeding wire can be connected to the pattern on the obverse side to feed power thereto by taking advantage of the feeding pattern formed on the reverse side, connecting the ground line of the feeding wire to the ground point on the obverse side, and connecting the voltage line of the feeding wire to the silver through-hole connected to the feeding pattern.

A formation of a cover film is useful to protect the conductive foil from oxidization or short-circuit caused by a soldering process. A formation of a positional aperture in the cover film formed by cutting a portion of the cover film corresponding to the ground point is also useful, because it enables the ground line of the feeding wire to be positioned accurately in a connection work. The positional aperture is formed in the cover film to expose the conductive foil therefrom and a size of the positional aperture is chosen to be useful as an indicator about the location of the ground point connected with the ground line. Formed by the etching process like the formation of the pattern, the positional aperture can be located precisely in the FPC. Broader area of the electrical ground can provide stable electrical potential for the antenna. But thermal diffusion may arise to solder the ground line to the ground point formed in the electrical ground with broader area, where the temperature does not rise sufficiently to secure a quality of soldering. A thermal land is provided for the antenna in the present invention to secure the quality of soldering the feeding ground line of the feeding wire.

Another aspect of the present invention provides the planar broadband inverted F-type antenna, having a pattern formed by etching a conductive foil laminated on an obverse side and a reverse side of a base film. The antenna is used for a first frequency band, and is connectable with a feeding wire. The antenna comprises; an electrical ground having a ground point connectable to a ground line of the feeding wire, and being formed on the obverse side of the dielectric layer; a first element having a plurality of emission patterns, each emission pattern being adaptable to the first frequency band, each pattern having a length varying from each other, and said first element being formed on the obverse side of the base film; a second element connecting each emission pattern of said first element to said electrical ground, and being formed on the obverse side of the base film; and a feeding pattern having a feeding terminal connectable to a voltage line of the feeding wire, being connected to said second element, and being formed on the reverse side of the base film. The feeding pattern includes a parallel wiring component to the emission patterns of said first element, said feeding pattern is positioned to overlap a vertical projection with at least one of the emission patterns of the first emission element so that a phase adjustment is provided to decrease a voltage standing wave ratio.

The phase adjustment can realize a more efficient antenna characterized in more decreased VSWR. The phase adjustment is realized by means of making a magnetic flux generated by the high-frequency current flowing in the emission pattern interlinkage with the voltage line of the feeding wire so as to decrease a reflective voltage from the antenna. The emission pattern and the feeding wire are arranged so that they approach with each other and the feeding wire is positioned to make the reverse voltage act to the reflective voltage in the voltage line of the feeding wire in order to provide the phase adjustment. Providing the stable phase adjustment at a time of the mass-production is not easy even though the best positioning of the feeding wire is achieved in advance, because a fine manufacturing process is required to achieve the phase adjustment correctly. However formed at a predetermined location precisely, the feeding pattern as a part of the feeding wire can be fixed at the arrangement between the feeding pattern and the emission patterns to adjust the phase of the reflective voltage so as to obtain the thin planar inverted F-type antenna adaptable to the broadband use and suitable to the mass-production.

The present invention could provide the small, thin, and lightweight planar broadband inverted F-type antenna. Moreover the present invention could provide the planar broadband inverted F-type antenna realized by means of etching the FPC. Still moreover the present invention could provide the planar broadband inverted F-type antenna adaptable to the bandwidth specified in the IEEE standard. The present invention could provide the planar broadband inverted F-type antenna to be able to obtain the stable characteristics in the mass-production.

### BRIEF DESCRIPTION OF THE DRAWINGS

FIG. 1 is a schematic diagram and a graph showing the emission patterns and the VSWR according to the antenna structure in the prior art.

FIG. 2 is a schematic diagram showing a plan view of the planar broadband antenna.

FIG. 3 is an enlarged diagram of the elements in the planar broadband antenna shown in FIG. 2.

FIG. 4 is a schematic diagram of the antenna shown in FIG. 2 to which the feeding wire is connected.

FIG. 5 is a schematic diagram of another embodiment characterized in the emission pattern.

FIG. 6 is a schematic diagram of another embodiment characterized in the mounted chip antenna.

FIG. 7 is a schematic diagram of another embodiment characterized in the feeding pattern on the obverse side of the FPC.

FIG. 8 is a schematic diagram of another embodiment characterized in the feeding pattern on the reverse side of the FPC.

FIG. 9 is a schematic diagram of another embodiment characterized in the lengthened pattern.

FIG. 10 shows the thermal land formed at the ground point.

FIG. 11 shows a relationship between the number of the emission patterns and the VSWR.

FIG. 12 shows a relationship between the number of the emission patterns and the VSWR.

FIG. 13 shows a contribution of each emission pattern to reduce the VSWR at each frequency in the bandwidth.

FIG. 14 shows a relationship between the number of the emission patterns and the bandwidth for the antenna before and after the phase adjustment.

FIG. 15 shows specifications of the emission patterns used for the experiment of the phase adjustment.

FIG. 16 shows a structure of the feeding wire used for the experiment of the phase adjustment.

FIG. 17 shows the measured bandwidths of the antenna with eight emission patterns before and after the phase adjustment.

FIG. 18 shows the measured bandwidths of the antenna with six, seven, and nine emission patterns respectively before and after the phase adjustment.

FIG. 19 shows waveforms of the VSWR about the antenna with eight emission patterns before and after the phase adjustment.

FIG. 20 shows waveforms of the VSWR about the antenna with six emission patterns before and after the phase adjustment.

FIG. 21 shows a structure to realize the phase adjustment by means of the feeding pattern formed on the reverse side.

FIG. 22 shows the measured bandwidth of the antenna in FIG. 21.

FIG. 23 shows gain characteristics of the antenna.

FIG. 24 shows a manufacturing process of the planar inverted F-type antenna by means of etching the FPC.

### DETAILED DESCRIPTION OF THE INVENTION

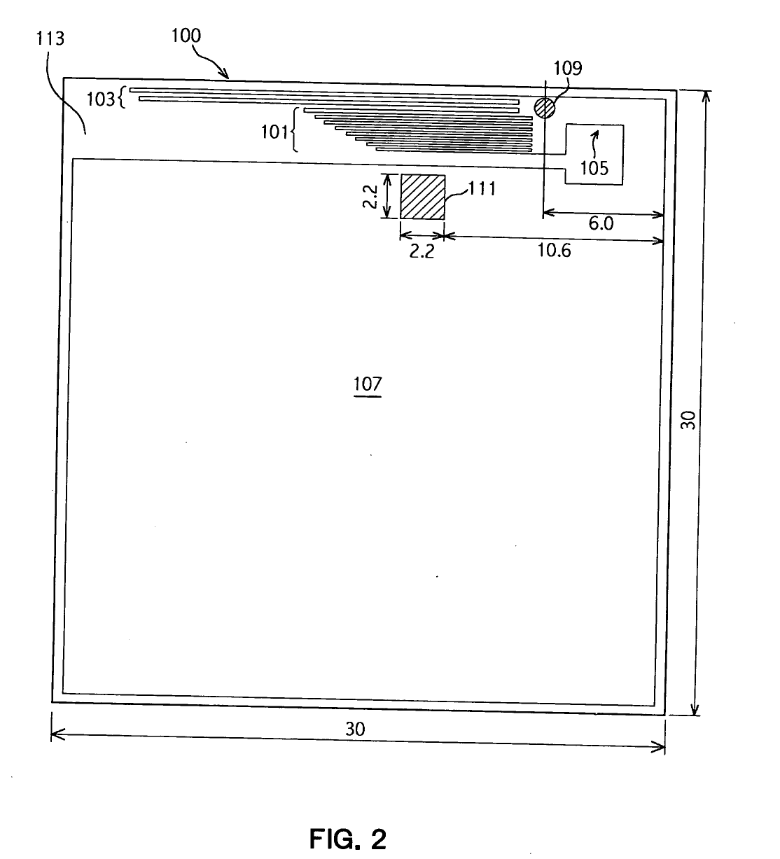

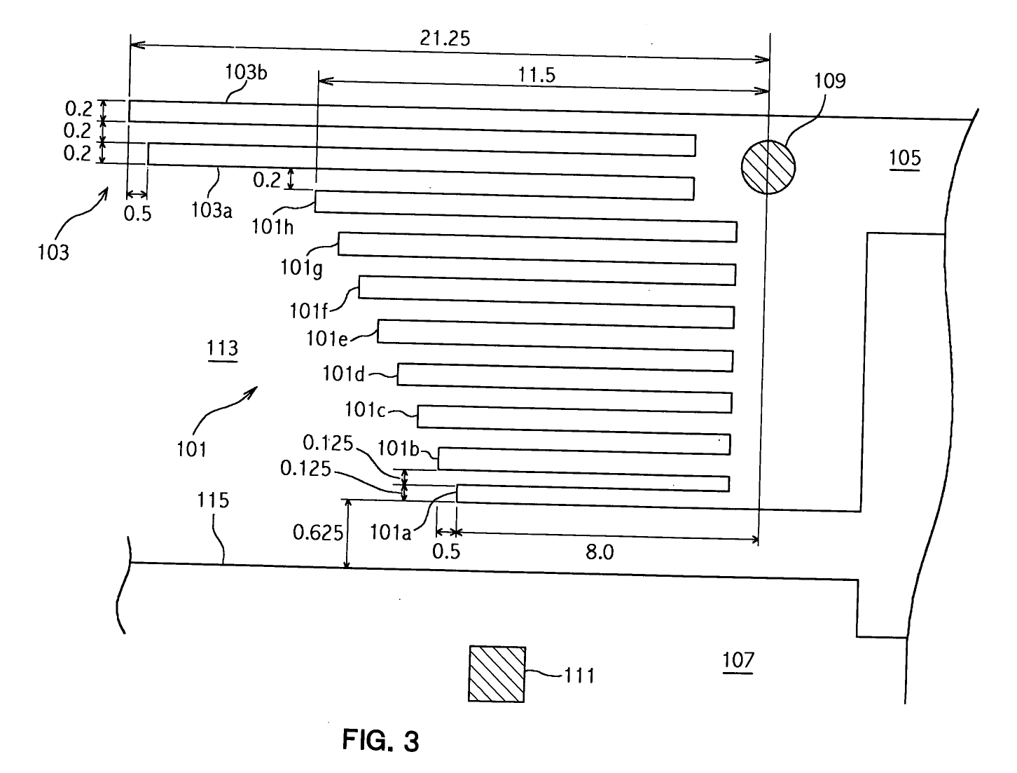

FIG. 2 is a plane view illustrating the planar broadband inverted F-type antenna (referred as antenna hereafter) according to an embodiment of the present invention. FIG. 3 is an enlarged view of emission patterns of the 5.0 GHz element 101 and emission patterns of the 2.4 GHz element 103. An identical reference number is assigned to an identical element through the specifications entirely. The antenna 100 is manufactured by applying an etching (lithography) technology to a copper foil layer of a commercial FPC corresponding to the conductive layer, where the copper foil layer is laminated on one side or both sides of a polyethylene terephthalate (PET) film 113 corresponding to the base film. A polyimide film can be used as a base film of the FPC.

A method for manufacturing the antenna by means of etching the FPC will be explained in detail later. The cover film is provided on the copper foil layer to be protected from oxidization or adherent of solder splash generated during soldering process. Only the copper foil layer on the PET film 113 from which the cover film is removed is shown in FIG. 2, FIG. 3. The antenna 100 is constituted to be adapted to two frequency bands of 5.0 GHz and 2.4 GHz. The rectangle copper foil layer with 30 mm×30 mm in size laminated on the PET film 113 is etched to form the patterns to manufacture the antenna 100. The patterns include long and narrow eight emission patterns 101a-101h constituting the 5.0 GHz element 101, long and narrow two emission patterns 103a, 103b constituting the 2.4 GHz element 103, an electrical ground 107 provided with a ground point 111, and a connection element 105 connecting the 5.0 GHz element and the 2.4 GHz element to the electrical ground 107.

The connection element 105 is provided with a feeding point 109. A coaxial cable corresponding to the feeding wire is to be connected to the feeding point 109 and the ground point 111. An inner conductor of the coaxial cable corresponding to the voltage line is to be connected to the feeding point 109, and an outer conductor of the coaxial cable corresponding to the ground line is to be connected to the ground point 111 to constitute the inverted F-type antenna.

The electrical ground 107 occupies most of an area of the patterns formed in the copper foil layer. It is preferable for the electrical ground 107 to have the area as large as possible to provide stable ground potential for the 5.0 GHz element 101, the 2.4 GHz element 103, and the connection element 105. The ground point 111 which is positioned by using the positioning aperture formed in the cover film is a part of the copper foil layer. The best location of the ground point 111 is searched from a plurality of locations where the outer conductor of the coaxial cable is connected respectively to conduct an examination in a trial production stage.

The positioning aperture conformed to the ground point 111 and formed in the cover film permits the antenna in the mass-production to obtain the good VSWR stably, because the outer conductor of the coaxial cable can be connected to the precise position in the electrical ground 107. The positioning aperture is 2.2 mm×2.2 mm in size in the embodiment according to the present invention. A distance from an edge of the copper foil pattern to an edge of the positioning aperture or the ground point 111 is 10.6 mm long and a distance from the edge of the copper foil pattern to the feeding point 109 is 6.0 mm long. The feeding point 109 which is positioned by the positioning aperture formed in the cover film is a part of the copper foil layer as well as the ground point 111.

Each of the eight emission patterns 101a-101h constituting the 5.0 GHz element 101 has a length adaptable to a frequency of the 5.0 GHz band at lambda/4 (where lambda is the wavelength) to constitute the inverted F-type antenna cooperatively together with the electrical ground 107 and the connection element 105. The emission pattern 101a is the shortest one among the emission patterns of the 5.0 GHz element 101, and has 8 mm long from the feeding point 109. The lengths of the emission patterns of the 5.0 GHz element 101 and the 2.4 GHz element 103 are measured from the feeding point 109 to the top of each emission pattern. The emission pattern 101a is arranged in parallel with an edge 115 of the electrical ground 107, and spaced 0.625 mm long therefrom.

The emission patterns 101b-101h varies by 0.5 mm long in sequence from the longest emission pattern to the shortest emission pattern, and the longest emission pattern 101h is 11.5 mm long from the feeding point 109. Each emission pattern 101a-101h is 0.125 mm in width of a pattern and 0.125 mm in width of a space which produce 0.25 mm in pitch of the pattern. Each emission pattern 101a-101h has the same difference in length from the adjacent emission patterns, and elongated from the emission pattern 101a to the emission pattern 101h. Each emission pattern can take its share at the resonant frequency in balancing effectively within the 5.0 GHz band to decrease the VSWR. In order to change the number of the emission patterns and to allow them to share the resonant frequencies evenly, both lengths of the longest emission pattern and the shortest emission pattern are decided based on the frequency at a upper limit and a lower limit of the bandwidth in the required frequency band, and other lengths of the residual emission patterns are decided to vary by the same length.

The number of the emission patterns 101a-101h can be increased moreover, but it will be affected and limited by the resonant frequency in the bandwidth of the antenna, the size of the rectangle copper foil, and a precision of the etching process applied to the FPC. The precisions are 0.05 mm long both about the pattern width and the space width, and 0.1 mm long about the pattern pitch in today's technology. The 5.0 GHz element 101 provided with the eight emission patterns 101a-101h and the connection element 105 can decrease the VSWR required for the bandwidth of the 5.0 GHz band. The longest emission pattern 101h corresponds to the lowest frequency 4.900 GHz in the bandwidth and the shortest emission pattern 101a corresponds to the highest frequency 5.875 GHz in the bandwidth. The emission patterns 111b-101g correspond to the frequencies between the highest frequency and the lowest frequency. This means that the emission patterns 101a-101h can resonate at any frequencies included in the bandwidth of the 5.0 GHz band. But it should be noticed that each emission pattern 101a-101h resonates as a whole together with the connection element 105, and the property has different significance from another property which will be obtained by combining all properties each of which is measured about an antenna structure including any one emission pattern in the emission patterns 101a-101h and the connection element 105.

Each of the two emission patterns 103a, 103b constituting the 2.4 GHz element 103 has a length adaptable to the frequency required for the 2.4 GHz band at lamda/4. The length of the emission pattern 103b adaptable to the 2.4 GHz band at lambda/4 decides the pattern size of 30 mm×30 mm approximately. The emission pattern 103a has 20.75 mm long, and the emission pattern 103b has 21.25 mm long. The widths of the pattern and the space are 0.2 mm respectively. Only two emission patterns 103a, 103b can make the VSWR 2.0 or less between 2.412 GHz and 2.486 GHz because of the narrow bandwidth required for the 2.4 GHz band. The plurality of precise emission patterns constituting the 5.0 GHz element and the 2.4 GHz element are easily and precisely formed by etching the FPC. However well known semiconductor process such as the chemical vapor deposition or the photolithography is applicable to form the emission pattern.

A strict parallel arrangement of the emission patterns is not essential, though each emission pattern of the 5.0 GHz element and the 2.4 GHz element is aligned in parallel with the edge 115 of the electrical ground 107 as shown in FIG. 2 and FIG. 3, and they may be aligned slightly obliquely thereto. The differential length, the width, and the space of the emission patterns are not confined to the embodiment shown in FIG. 3, therefore they can be modified to adjust characteristic impedance of each emission pattern at discretion.

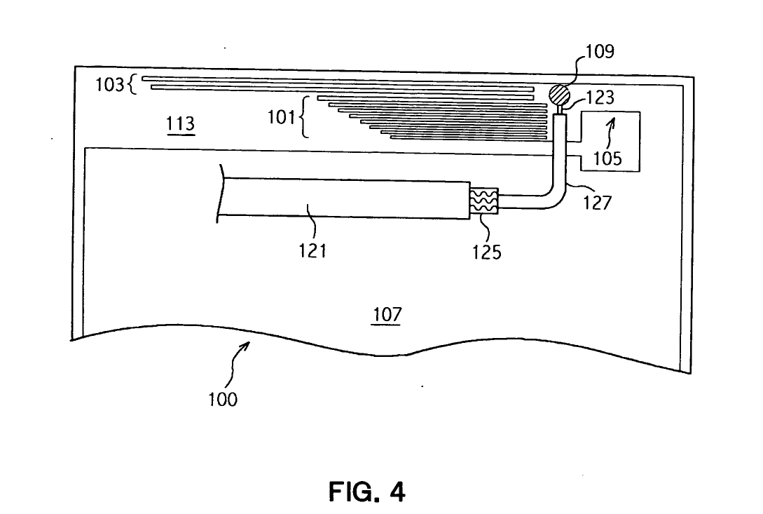

Referring to FIG. 4, a coaxial cable 121 is connected to the antenna 100. The coaxial cable 121 has an insulator 127 between an outer conductor 125 and an inner conductor 123 and formed in a concentric cylinder shape. The outer conductor 125 is soldered to the ground point 107 (shown in FIG. 2) and the inner conductor 123 is soldered to the feeding point 109. The other end of the coaxial cable 121 is connected to a transmitter or a receiver connected with a LAN card equipped in the information terminal. Impedance value of the coaxial cable 121 in a total length is 50 ohm in this embodiment, but other impedance values are applicable to constitute the antennas suitable for the impedance value.

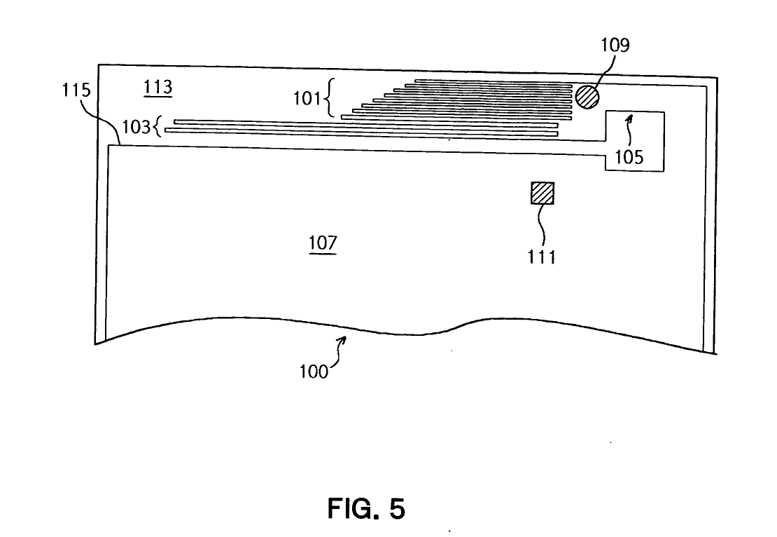

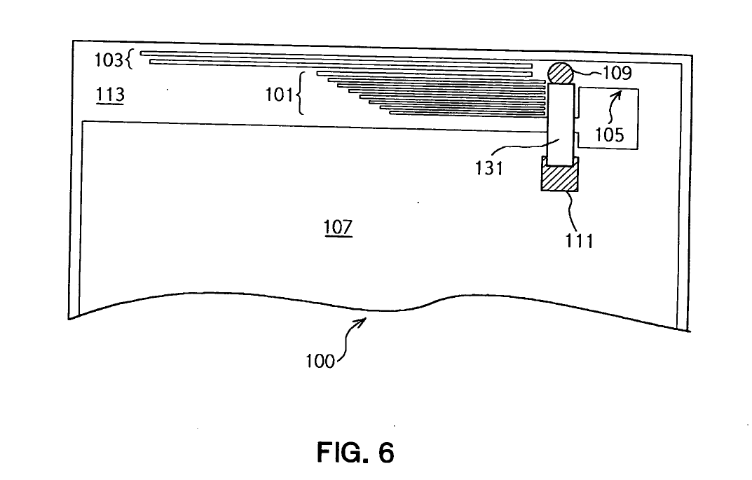

FIG. 5 shows an embodiment disposing the emission patterns of the 5.0 GHz element 101 and the 2.4 GHz element 103 to shorten the length of each pattern in sequence according to a distance parting from the edge 115 of the electrical ground 107. FIG. 6 shows an embodiment providing a chip-antenna 131 connected to the feeding point 109 and the ground point 111 of the antenna 100 shown in FIG. 2. The chip-antenna 131 is a mono-pole antenna made of high dielectric constant materials, and a peculiarity enabling the antenna to use a shorter element than the inverted F-type antenna to the same frequency permit a multi-frequency antenna adaptable to more bandwidths in combination with the 5.0 GHz element 101 and the 2.4 GHz element 103 to be manufactured.

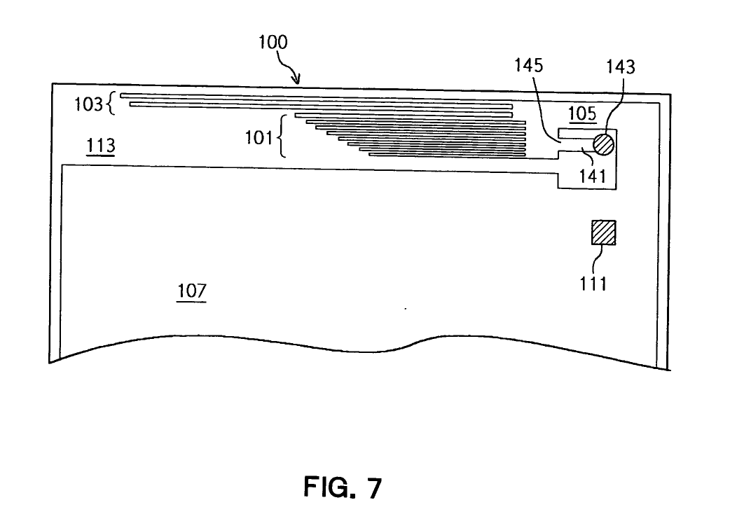

FIG. 7 is an embodiment providing a feeding pattern 141 in the copper foil layer of the antenna 100 shown in FIG. 2. In the embodiment shown in FIG. 4, the inner conductor 123 can be connected to the feeding point 109 of the connection element 105, but it may invite a hurdle to solder the inner conductor 123 to the feeding point 109 accurately in the mass-production. The higher the frequency is, the larger a change of the property is in case of a slight location shift of the inner conductor 123 from the best location in the feeding point 109, which should be canceled consequently. With respect to this point, the feeding pattern 141 having a feeding terminal 143 connectable to the inner conductor 123 works as an extension of the inner conductor 123 to the connection element 105, therefore a location 145 can be regarded as the feeding point to the connection element 105.

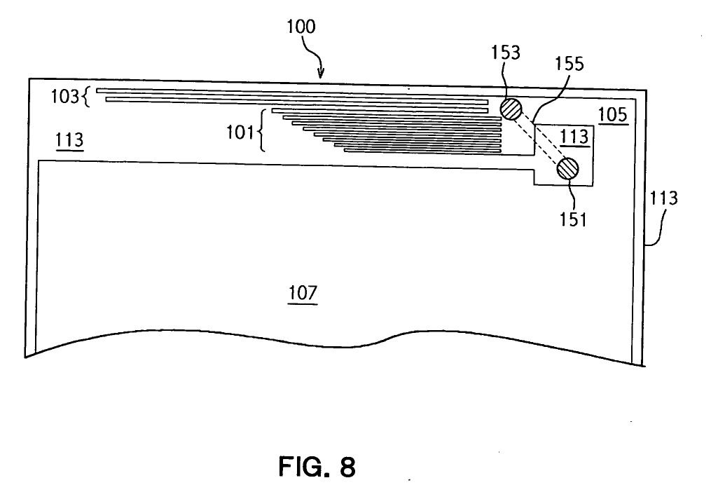

The feeding pattern 141 being formed by means of the etching process to the copper foil layer, the feeding point 145 can be secured accurately in this embodiment. FIG. 8 is an embodiment showing another power feeding method to the antenna 100. A feeding pattern 155 of the copper foil layer is formed on a reverse side of the PET film 113 in this embodiment. A feeding terminal 151 used for the connection of the inner conductor 123 is formed at a location where the pattern of the copper foil layer is not formed on the obverse side of the PET film 113. The feeding terminal 151 is at one end of a silver through-hole which connects between the obverse side and the reverse side of the PET film 113 electrically. The silver through-hole is electrically connected to the feeding pattern formed in the copper foil layer on the reverse side. A detail of forming the silver through-hole will be explained later.

The feeding pattern 155 extends on the reverse side of the PET film 113 to a location corresponding to a feeding point 153, and electrically connected to the connection element 105 which is a part of the copper foil layer on the obverse side through the silver through-hole. This power feeding method permit the antenna 100 to obtain the better VSWR, because an optimum feeding route can be formed in the copper foil layer on the reverse side escaping from an interference caused by the pattern on the obverse side. The feeding pattern 155 can secure the location of the feeding point 153 to the connection element 105 accurately, being formed by means of the etching process as well as the embodiment shown in FIG. 7. The feeding terminal 151 can be formed at the other end of the feeding pattern 155 on the reverse side. Remarkably, the antenna can receive the power from the reverse side with the coaxial cable 121 is to increase a liberty of the installation in the small mobile information terminal having narrow space, feeding the power to the feeding terminal 151 formed in the feeding pattern 155 on the reverse side, and extending the silver through-hole connected to the electrical ground 107 to the reverse side.

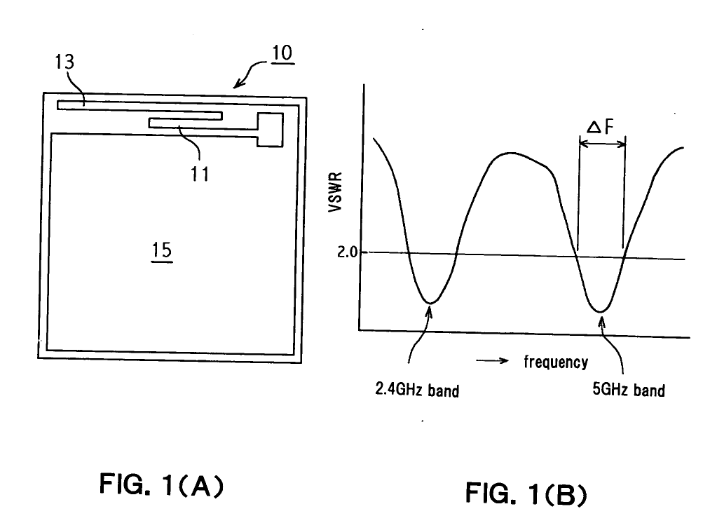

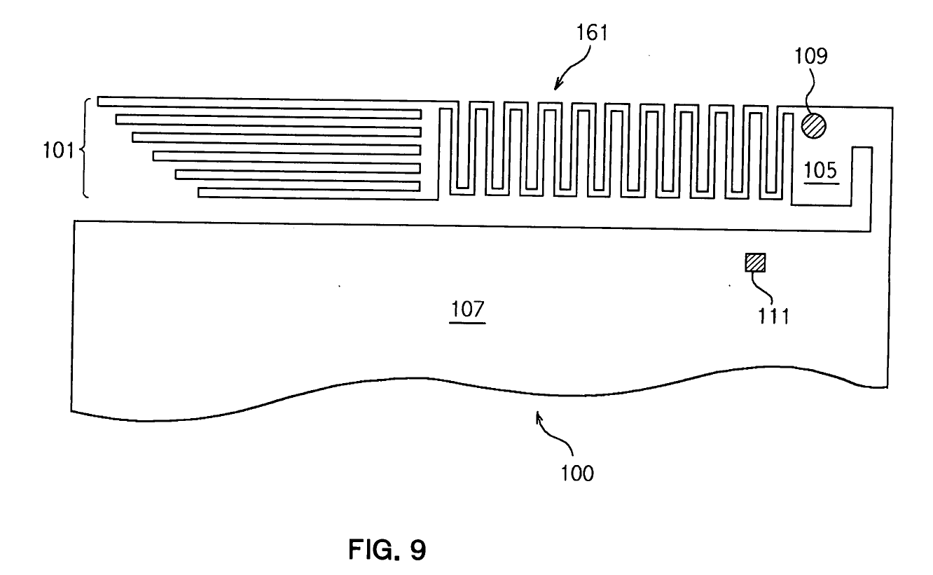

FIG. 9 is an embodiment of the antenna 100 adaptable to the lower frequency band in spite of having a small size of the copper foil layer. A lengthened pattern 161 is formed between the feeding point 109 and the 5.0 GHz element 101 in the antenna 100. The lengthened pattern 161 works to make the antenna 100 adaptable to the lower frequency band, lengthening the length of the antenna element to flow current. The lengthened pattern 161 can adopt other shapes such as a saw edge or a coil other than the shape shown in FIG. 9. When the lengthened pattern 161 is formed in the copper foil layer on the reverse side and connected to the pattern of the copper foil layer on the obverse side via the silver through-hole instead of being formed in the copper foil layer on the obverse side, longer pattern can be obtained escaping from an interference by the antenna element about the space. The antenna shown in FIG. 1 is made adaptable to a UHF band, adopting the 20 cm-30 cm long lengthened pattern.

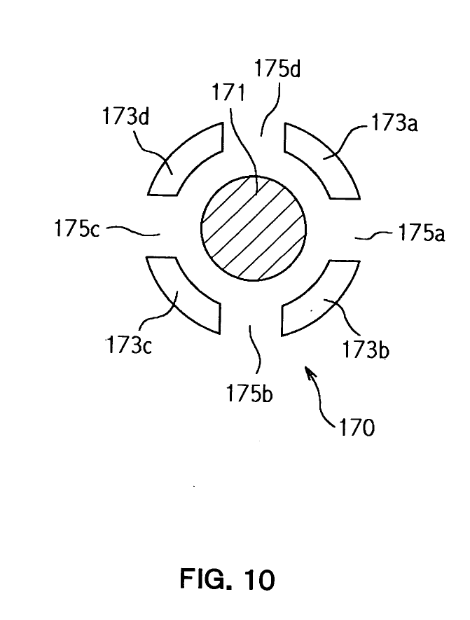

FIG. 10 shows a thermal land 170 formed in the ground point 111 shown in FIG. 2. Heat tends to diffuse when the outer conductor 125 is soldered to the ground point 111, the electrical ground 107 being constituted to have relatively broad area. Quality of soldering deteriorates, if a temperature at the ground point 111 does not rise enough for soldering. The thermal land 170 shown in FIG. 10 has peripheral apertures 173a-173d around a connection terminal 171. Each of the peripheral apertures 173a-173d is a region where the copper foil layer of the electrical ground 107 is partially removed to expose the PET film 113.

The heat diffuses to whole of the electrical ground 107 while conducting through conduction regions 175a-175d, when the outer conductor 125 of the coaxial cable 121 is soldered to the connection terminal 171. The peripheral apertures 173a-173d slow down velocity of the heat diffusion, providing smaller area used for the heat conduction. Therefore high temperature at the connection terminal 171 can be maintained for a while. The thermal land 170 works to limit a route of the heat diffusion within the conduction regions 175a-175d, accordingly other patterns are applicable as far as they work similarly without limitation of the pattern shape shown in FIG. 10.

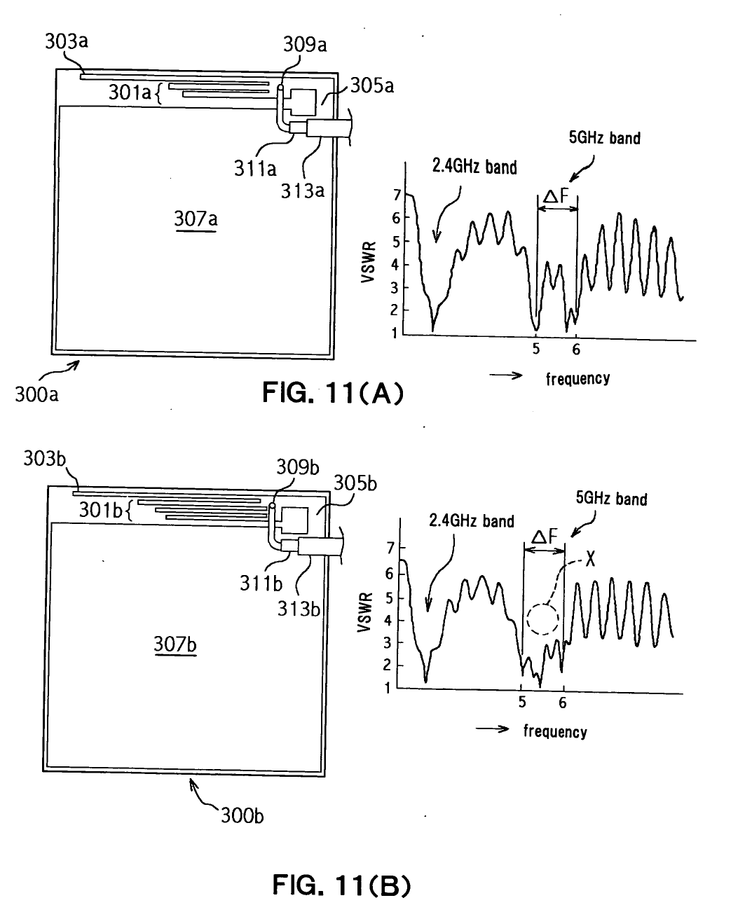

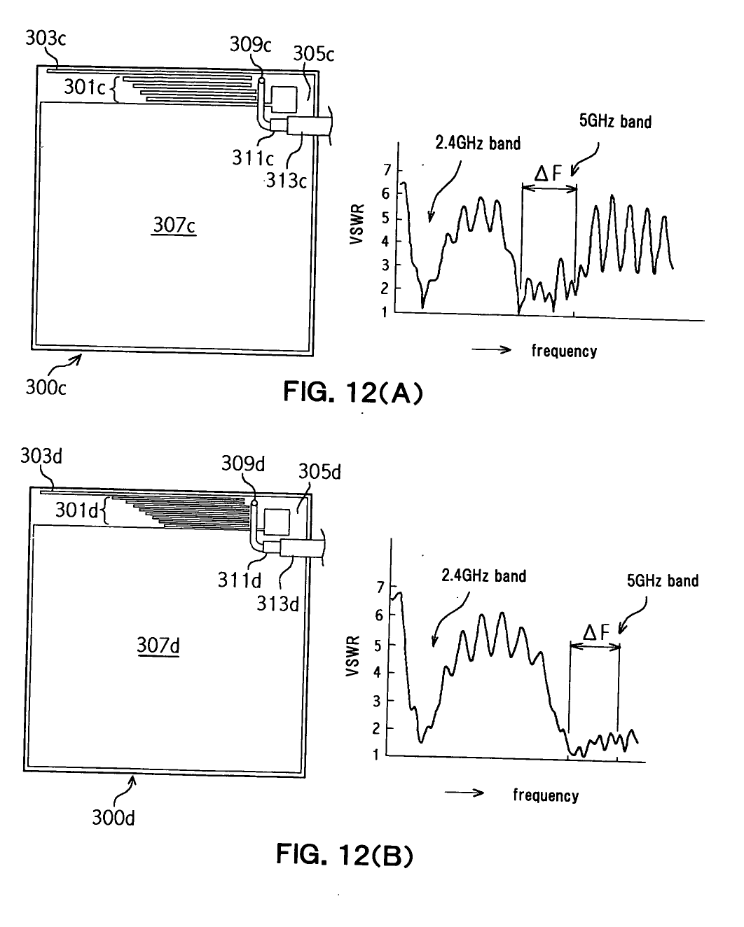

Referring to FIG. 11 and FIG. 12, relationships between the number of the emission patterns and the VSWRs corresponding to each other in the 5.0 GHz bandwidth are explained. The antenna 300a-300d shown in FIG. 11(A), FIG. 11(B), FIG. 12(A), and FIG. 12(B) include the 5.0 GHz element 301a-301d, the 2.4 GHz element 303a-303d, the connection element 305a-305d, and the electrical ground 307a-307d respectively. An outline of the entire pattern is 30 mm×30 mm as well as one show in FIG. 2. The inner conductor of the coaxial cable 313a-313d is connected to the connection element 305a-305d at the feeding point 309a-309d, and the outer conductor of the coaxial cable 313a-313d is connected to the electrical ground 307a-307d at the ground point 311a-311d respectively.

The antenna 300a shown in FIG. 11(A) includes the 5.0 GHz elements 301a composed of the two emission patterns and the 2.4 GHz element 303a composed of the one emission pattern. The 2.4 GHz element 303a is 21.9 mm long from the feeding point 309a to the top of the emission pattern, and the 2.4 GHz element 303b-303d are the same likewise respectively. The emission patterns of the 5.0 GHz element 301a are 10.6 mm long and 12.7 mm long from the feeding point 309a to the top of each emission pattern. In consideration of the VSWR property of the antenna 300a, many portions exceeding the VSWR 2.0 in the bandwidth delta F of 4.900 GHz-5.875 GHz in the 5.0 GHz band illustrate the unsatisfactory VSWR property.

The antenna 300b shown in FIG. 11(B) includes the 5.0 GHz element 301b composed of the three emission patterns each of which is 10.6 mm long, 11.6 mm long, and 12.7 mm long respectively. In consideration of the VSWR property of the antenna 300b, it is improved at a portion indicated as X. The antenna 300c shown in FIG. 12(A) includes the 5.0 GHz element 301c composed of the four emission patterns each of which is 9.6 mm long, 10.6 mm long, 11.6 mm long, and 12.7 mm long respectively. In consideration of the VSWR property for the antenna 300c, it is found that the VSWR property in the bandwidth of the 5.0 GHz band is improved compared to the antenna 300b.

The antenna 300d shown in FIG. 12(B) includes the 5.0 GHz element 301d composed of the eight emission patterns each of which is 8.0 mm long, 8.5 mm long, 9.0 mm long, 9.5 mm long, 10.0 mm long, 10.5 mm long, 11.0 mm long, and 11.5 mm long respectively. In consideration of the VSWR property of the antenna 300d, it is found that the delta F in the 5.0 GHz bandwidth which gives the VSWR of 2.0 or less is broader than any other antenna. These samples of the antennas can not achieve the VSWR 2.0 or less over the frequencies in the bandwidth specified in the IEEE standard. However this does not mean that the antenna composed of these features can not meet the requirement of the bandwidth specified in the IEEE standard. The VSWR property of the antenna used for the higher frequency tends to vary affected by the slight shift of the connecting location of the feeding wire or the slight change of the pattern shape. It was verified in other experiments that the antenna with eight emission patterns could meet the requirement of the IEEE bandwidth where the VSWR is less than or equal to 2.0.

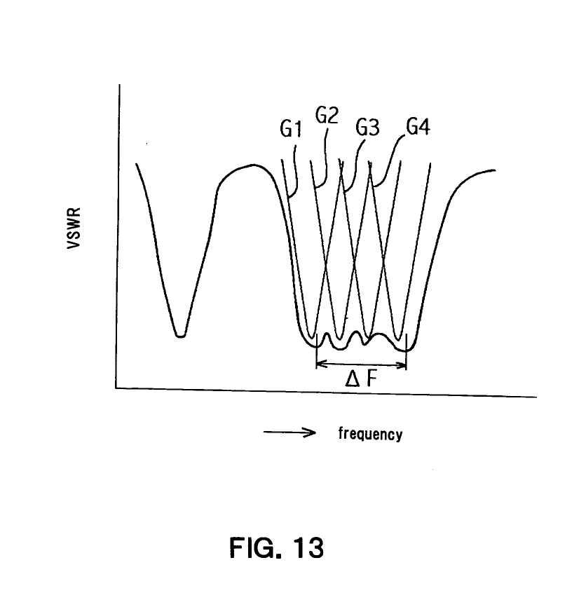

FIG. 13 shows a mechanism how each emission pattern of the element contributes to decrease the VSWR in the 5.0 GHz bandwidth. FIG. 13 explains about the case consisting of four emission patterns. Every pattern of the four patterns resonates at the frequency included in the bandwidth of the 5.0 GHz band, and each length of the emission patterns between the longest pattern and the shortest pattern is decided to vary in even difference. A line G1 is a hypothetical VSWR to show the state that the longest emission pattern contributes to decrease the VSWR. A line G4 is a hypothetical VSWR to show a state that the shortest emission pattern contributes to decrease the VSWR. Line G2 and G3 are hypothetical VSWRs to show the states that the middle length emission patterns contribute to decrease the VSWR. The reason why the hypothetical VSWR is brought is that the VSWR obtained from the antenna with four emission patterns does not correspond to the VSWR obtained from combining the four VSWR properties each of which is measured about an antenna structure provided with only one emission pattern whose length is varied from others.

In the antenna provided with four emission patterns, the entire VSWR property of the antenna is produced by each emission pattern which is mutually influenced. But it is apparent that the longest emission pattern resonates at the lowest frequency in the bandwidth to contribute to decrease the VSWR, and the shortest emission pattern resonates at the highest frequency in the bandwidth to contribute to decrease the VSWR as a result of an experiment. By increasing the number of the emission patterns between the longest emission pattern and the shortest emission pattern to some extent, it was verified in the experiment that projecting portions toward high value of the VSWR could be eliminated within the bandwidth delta F.

As mentioned above, it was verified that the bandwidth where the VSWR was 2.0 or less is expanded according to the increase of the number of the emission patterns in the antenna structure explained by referring to FIG. 2. An effect of the expanded bandwidth is not limited in the 5.0 GHz band. The antenna can expand the bandwidth to make the VSWR 2.0 or less in the 2.4 GHz band more than the conventional antenna with one emission pattern, being provided with two emission patterns. Furthermore, in other frequency bands, it is possible to expand the bandwidth where the VSWR is 2.0 or less by increasing the number of the emission patterns adaptable to each frequency required by the frequency band.

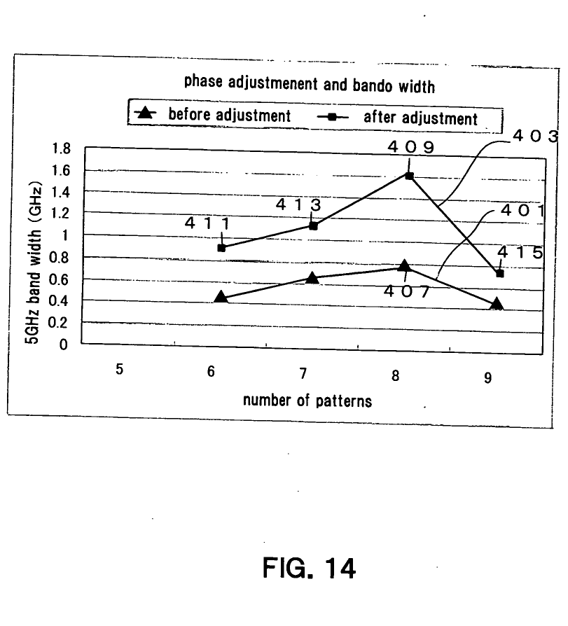

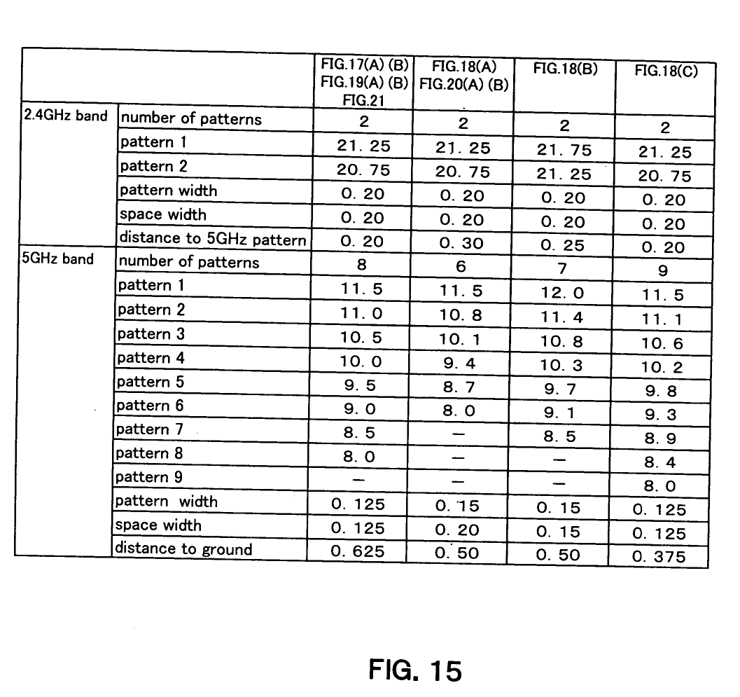

However, it was verified that the bandwidth where the VSWR was 2.0 or less expanded in response to the increase of the number of the emission patterns from two to eight, and that the bandwidth decreased when the number of the emission patters were increased more than nine. FIG. 14 shows a relationship between the number of the emission patterns and the correspondent bandwidth about antennas before and after the phase adjustment. Detail of the phase adjustment will be explained later. FIG. 15 is a list of the emission patterns about each antenna whose reference number is assigned in FIG. 14 where the 2.4 GHz element and the 5.0 GHz element are formed in the copper foil layer with 30 mm×30 mm in size respectively.

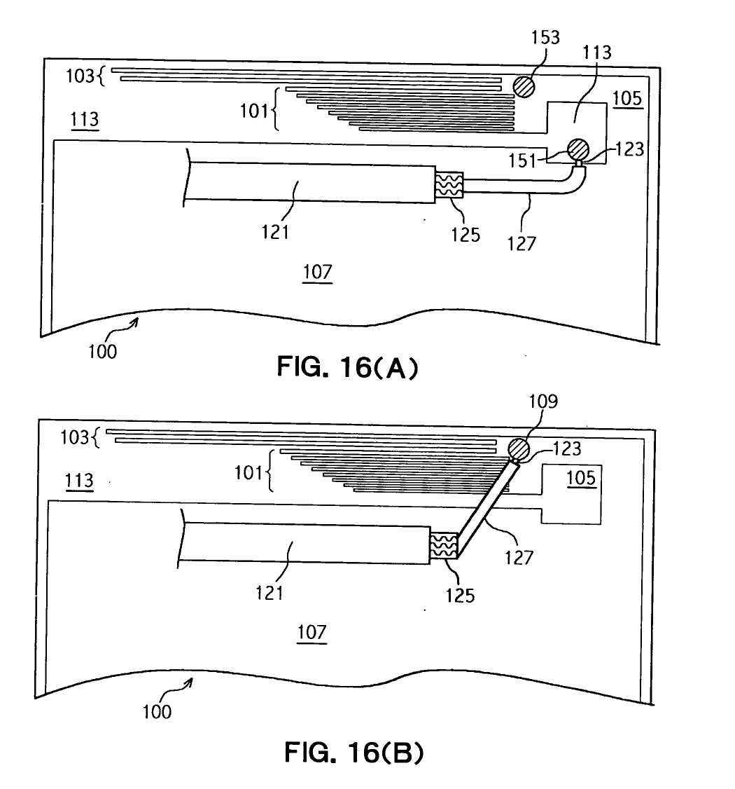

The bandwidth of each antenna is indicated in a line 401, where the number of emission patterns of the 5.0 GHz band is changed from six to nine. The VSWR is 2.0 or less in each bandwidth. A structure of each emission pattern corresponding to the number of the them is shown in FIG. 15. The power feeding to each antenna in the line 401 is conducted through the feeding pattern 155 shown in FIG. 8, and a structure where the coaxial cable 121 is connected is shown in FIG. 16 (A). The outside conductor 125 of the coaxial cable 121 is connected to the electrical ground 107 at the ground point, and the inner conductor 123 is connected to the feeding terminal 151.

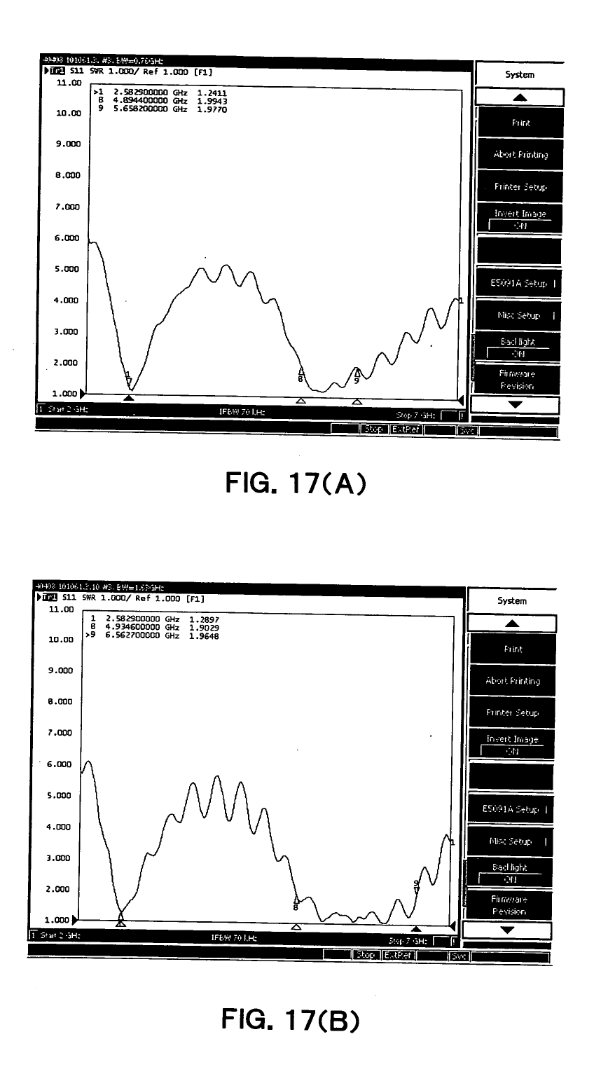

The line 401 shows that the eight mission patterns give a maximum bandwidth. FIG. 17 (A) shows a measured VSWR of the antenna 100 provided with the eight emission patterns in the 5.0 GHz element with the reference number 407 in the line 401. A network analyzer obtainable from Agilent Technologies Japan, Ltd. as Model 5071B was used to measure the VSWR. FIG. 17 (A) shows that the upper limit and the lower limit of the frequency where the VSWR is 2.0 or less in the 5.0 GHz band are 4.85 GHz and 5.65 GHz, whose bandwidth is corresponding to 0.76 GHz.

Adoption of the eight emission patterns gave the broadest bandwidth, however it could not meet the IEEE standard in the sample antenna. The reason why the bandwidth does not broaden in response to the increase of the number of the emission patterns nine or more is considered that the size of the copper film is defined based on the resonating frequency at lambda/4 to the operational frequency and the effect of the increase of the number of the emission patterns can not be obtained, because the width of the pattern and the width of the space between the patterns are narrow and impedance of each emission pattern varies.

The phase adjustment method is introduced in the present invention to enlarge the bandwidth within the size of the copper foil layer favorably to install the antenna in the small information terminal such as a cellular phone, the antenna having the rectangular copper foil layer 30 mm×30 mm in size to form the patterns provided in this embodiment. A line 403 in FIG. 14 shows the bandwidth of each antenna provided with the phase adjustment to make the VSWR 2.0 or less per the number of the emission patterns. Each antenna composing the line 403 has six to nine same emission patterns to correspond to each antenna composing the line 401, and only the structure of the power feeding is modified. Each antenna in the line 403 broadens the bandwidth by two times approximately to each correspondent antenna in the line 401, and the antennas with seven (reference number 413) and eight (reference number 409) emission patterns exceed the bandwidth of the 5.0 GHz band specified in the IEEE standard.

The phase adjustment in the present invention means to reduce reverse the voltage produced in the feeding wire by taking advantage of the interlinkage of magnetic field induced from high-frequency current in the feeding wire and magnetic field induced from high-frequency current in the emission pattern mutually and adding voltage with reverse phase to the reflective voltage. In the antenna 100 shown in FIG. 16 (A), the high-frequency current in the coaxial cable 121 allows the reflective voltage to return to the coaxial cable 121 at a connecting point between the feeding terminal 151 and the inner conductor 123 due to the reflection. The reflection voltage is generated from a difference between the characteristic impedance of the coaxial cable 121 and the characteristic impedance of the antenna 100. The reflective voltage should be reduced, inviting an inefficient power transmission from the transmitter to the antenna or returning the reflective current to the transmitter.

A reflective wave returns to the feeding wire as the current or the voltage, and the VSWR is used as an index to know a degree of the reflection through an indirect evaluation to an amount of the reflective voltage. Coupling the inner conductor 123 of the coaxial cable 121 and the 5.0 GHz emission patterns magnetically and adding the voltage of the reverse phase to the reflective voltage, the phase adjustment can reduce the reflective voltage.

The 5.0 GHz element of the antenna 100 is constituted by the plurality of emission patterns and the characteristic impedance varies from the patter to pattern, bringing the reflective voltages of various frequencies. Consequently, the antenna 100 for which the phase adjustment is not provided stands a good frequency and a bad frequency related to the VSWR in a predetermined bandwidth. An interrelated location between the feeding wire and the emission patterns is defined to provide the phase adjustment while observation of the VSWR is carried out. Reduction of the VSWR can be achieved to locate the feeding wire to include larger component in parallel with the emission pattern corresponding to the frequency about which the VSWR is to be decreased. Next, a specific way of the phase adjustment will be explained by referring to FIG. 16(B).

FIG. 16(B) shows that the coaxial cable 121 is connected to the antenna 100 to reduce the reflective voltage by means of the phase adjustment. The outer conductor 125 of the coaxial cable 121 is connected to the ground point 111 (shown in FIG. 2), and the inner conductor 123 covered with the insulator 127 extends to the feeding point 109 while crossing over or overlapping the 5.0 GHz emission patterns 101. The insulator 127 may contact with a cover film covering the emission patterns 101 or may separate therefrom.

The phase adjustment is provided for the antenna through the interlinkage of the magnetic field induced by the high-frequency current in the emission patterns. Therefore the arrangement of the inner conductor in a manner of having the component in parallel with the specific emission pattern intensifies the magnetic coupling therewith, and permits the phase adjustment to be provided about the specific frequency intensively. Preferable positional relation is defined by means of selecting a wiring root of the inner conductor as S shape or separating from the surface of the emission patterns (practically from the surface of the cover film).

For example, allowing the inner conductor 123 to include the close component in parallel with short patterns such as emission patterns 101a, 101b shown in FIG. 3 is effective to improve the VSWR related to the frequency adjacent to the upper limit of the 5.0 GHz bandwidth. A specific frequency to improve the VSWR is selectable while the waveform as shown in FIG. 17 is observed. An ideal phase adjustment results in overlapping a vertical projection of the inner conductor 123 with a part of 5.0 GHz emission patterns in general. However, providing the phase adjustment for the antenna is feasible to arrange the inner conductor 123 close to the emission pattern to form magnetic coupling with the emission patterns escaping from overlapping the vertical projection.

The arrangement to overlap the vertical projection with the emission patterns does not always make the reverse voltage act to the reflective voltage. If a positive phase voltage or a forward voltage acts to the reflective voltage, the VSWR will increase. Accordingly, the best wiring root of the inner conductor 123 is defined to add the reverse voltage to the reflective voltage from the diverse positional relations while the waveform of the VSWR is observed with the network analyzer.

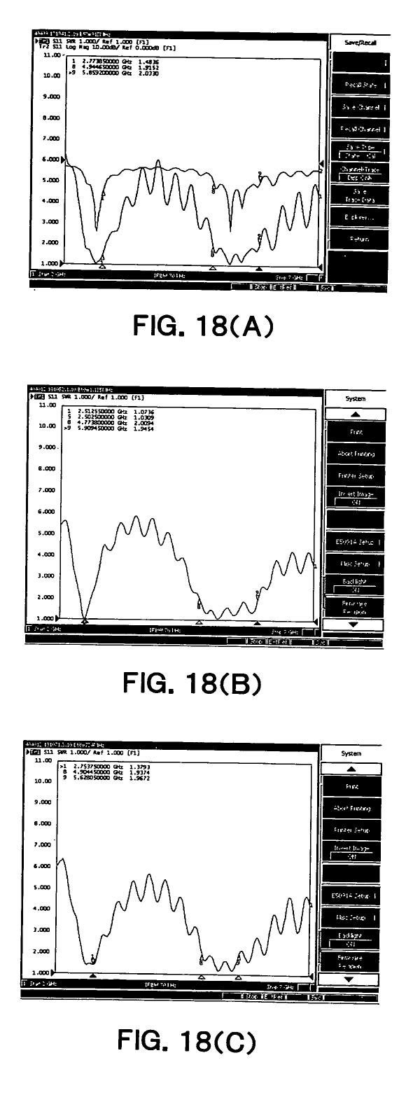

FIG. 17(B), FIG. 18(A)-FIG. 18(C) show the result of the bandwidth measured for each antenna provided with the phase adjustment, composing the line 403 in FIG. 14. A feeding method of each antenna is the same as one shown in FIG. 16(B) and the structures of the emission patterns are shown in FIG. 15. FIG. 17 (B) shows the result measured for the antenna with the eight emission patterns for the 5.0 GHz band (reference number 409), where the upper limit and the lower limit of the frequency to make the VSWR 2.0 or less are 6.56 GHz and 4.93 GHz respectively and the bandwidth is 1.63 GHz. FIG. 18(A) shows the result measured for the antenna with the six emission patterns for the 5.0 GHz band (reference number 411), where the upper limit and the lower limit of the frequency to make the VSWR 2.0 or less are 5.85 GHz and 4.94 GHz respectively and the bandwidth is 0.91 GHz. An upper line in FIG. 18(A) shows a return loss representing the loss produced from the reflection of the input power to the antenna.

FIG. 18(B) shows the result measured for the antenna with the seven emission patterns for the 5.0 GHz band (reference number 413), where the upper limit and the lower limit of the frequency to make the VSWR 2.0 or less are 5.90 GHz and 4.77 GHz respectively and the bandwidth is 1.13 GHz. FIG. 18(C) shows the result measured for the antenna with the nine emission patterns for the 5.0 GHz band (reference number 415), where the upper limit and the lower limit of the frequency to make the VSWR 2.0 or less are 5.62 GHz and 4.90 GHz respectively and the bandwidth is 0.72 GHz.

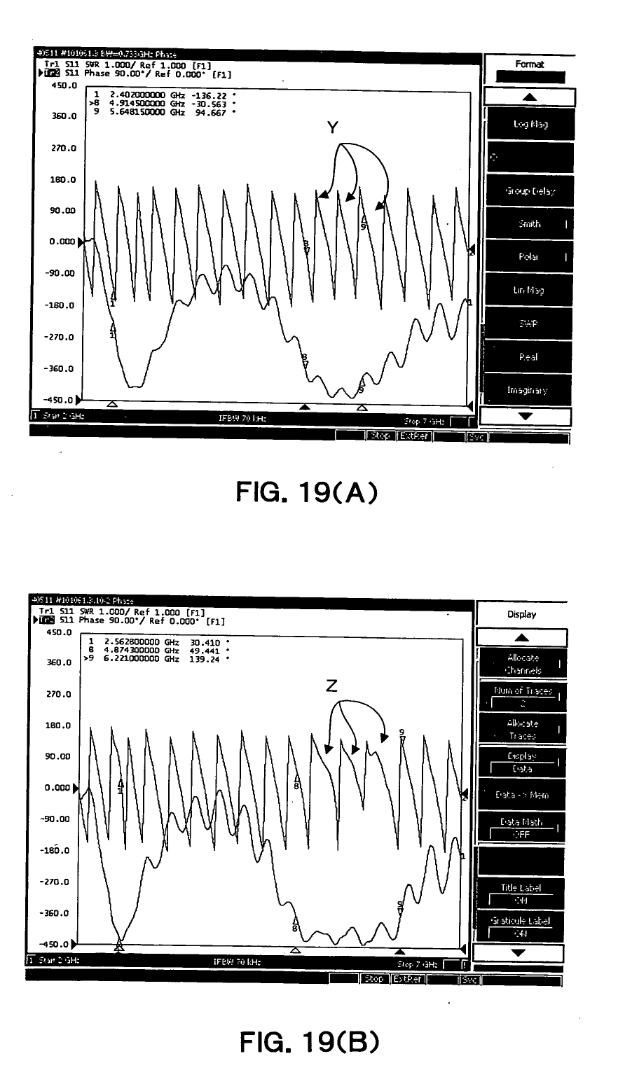

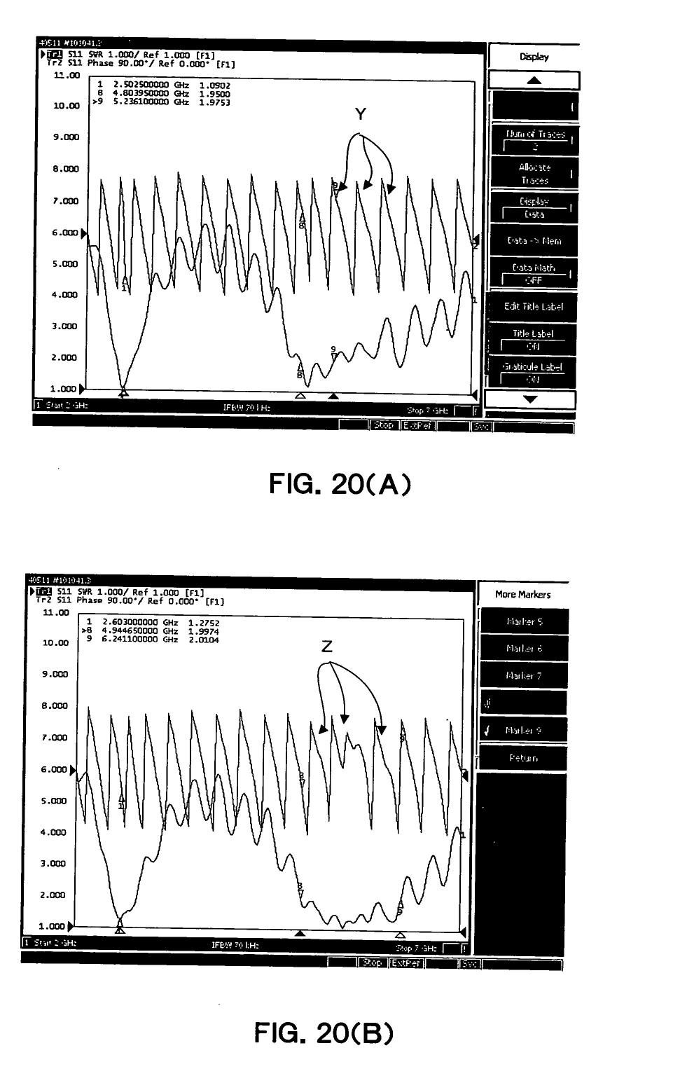

FIG. 19 and FIG. 20 show an example of a waveform indicating phase angle of the frequencies about the 5.0 GHz emission patterns before and after the phase adjustment. The observation of the waveform was carried out with the aforementioned network analyzer operating in “Phase Format Mode.” The phase format mode enables the network analyzer to measure and display the phase angle per frequency from minus 180 degree to plus 180 degree. FIG. 19 shows the case about the eight emission patterns and FIG. 20 shows the case about the six emission patterns. The vertical line is the phase angle and the horizontal line is the frequency in FIG. 19, and the vertical line is the VSWR and the horizontal line is the frequency in FIG. 20. An upper line represents the waveform of the phase angle and a lower line represents the waveform of the VSWR measured simultaneously with the phase angle in FIG. 19 and in FIG. 20. The network analyzer can display two waveforms at a time such as the upper line and the lower line and the scale of the vertical line is changeable to cope with it, accordingly the scale of the vertical line in FIG. 20 indicates the VSWR. Therefore contents of the measured waveforms in FIG. 19 and FIG. 20 are substantially equivalent to each other.

FIG. 19(A) and FIG. 20(A) illustrate the waveforms for the antenna for which the phase adjustment is not provided by means of the power feeding method shown in FIG. 16(A) and portions of the waveforms indicated by Y change smoothly. FIG. 19(B) and FIG. 20(B) illustrate the waveforms for the antenna provided with the phase adjustment by means of the power feeding method shown in FIG. 16(B) and portions of the waveforms indicated by Z change with swells or distortions which demonstrate that the phase changes by the magnetic coupling between the emission patterns resonating at the indicated frequency and the inner conductor 123 of the coaxial cable.

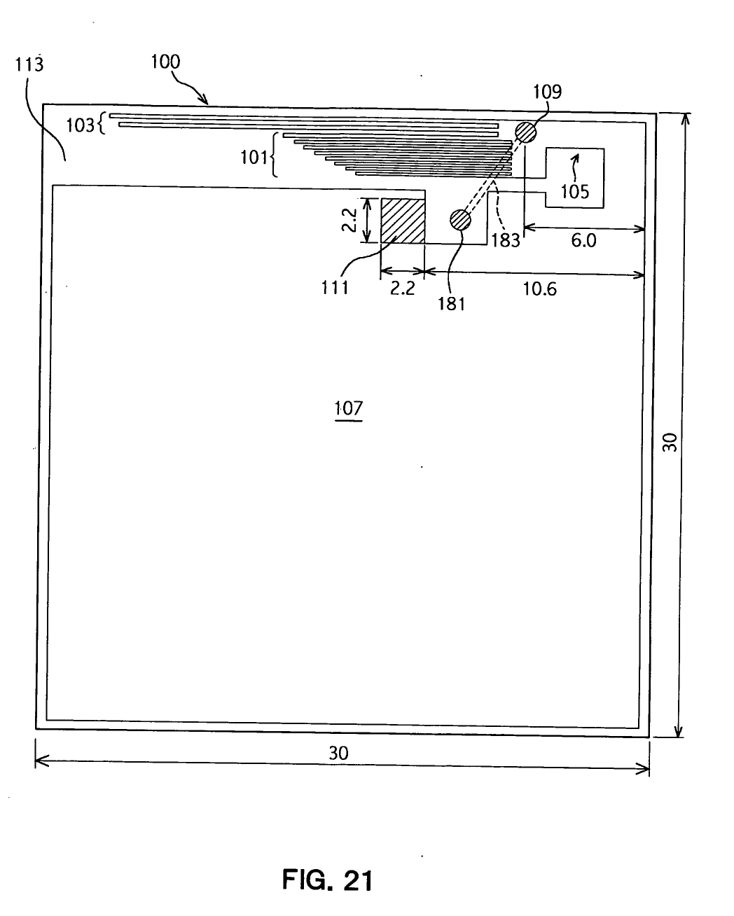

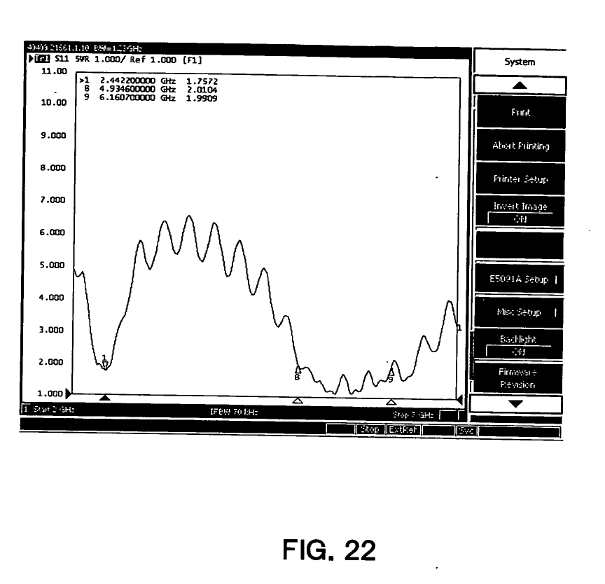

FIG. 21 and FIG. 22 show a structure to provide the phase adjustment for the antenna with eight emission patterns by means of using the pattern on the reverse side and the measured VSWR about the antenna. FIG. 21 illustrates a feeding pattern 183 formed in the pattern on the reverse side. One end of the feeding pattern 183 is connected to a feeding terminal 181 formed in a region where the ground pattern 107 is removed by way of the silver through-hole. The other end of the feeding pattern 183 is connected to the feeding point 109 of the connection element 105 by way of the silver through-hole. A difference from the feeding pattern 155 shown in FIG. 8 is that a vertical projection of the feeding pattern 183 to the copper foil layer overlaps with the emission patterns 101 of the 5.0 GHz element.

The structure enables the magnetic field induced by the high-frequency current in each emission pattern 101 to induce the reverse voltage to act to the reflective voltage and to decreases the VSWR when the inner conductor 123 of the coaxial cable 121 is connected to the feeding terminal 181 and the outer conductor 125 of the coaxial cable 121 is connected to the ground point 111 for the power feeding. The feeding pattern 183 used for the phase adjustment can be formed not only in the pattern on the reverse side of the PET film 113 but also formed on the emission pattern interposed by an insulation layer therebetween on the obverse side. FIG. 22 shows the measured VSWR about the antenna 100 provided with the phase adjustment by means of the feeding pattern shown in FIG. 21. The upper limit and the lower limit of the frequency to make the VSWR 2.0 or less are 6.61 GHz and 4.93 GHz respectively and the bandwidth is 1.23 GHz.

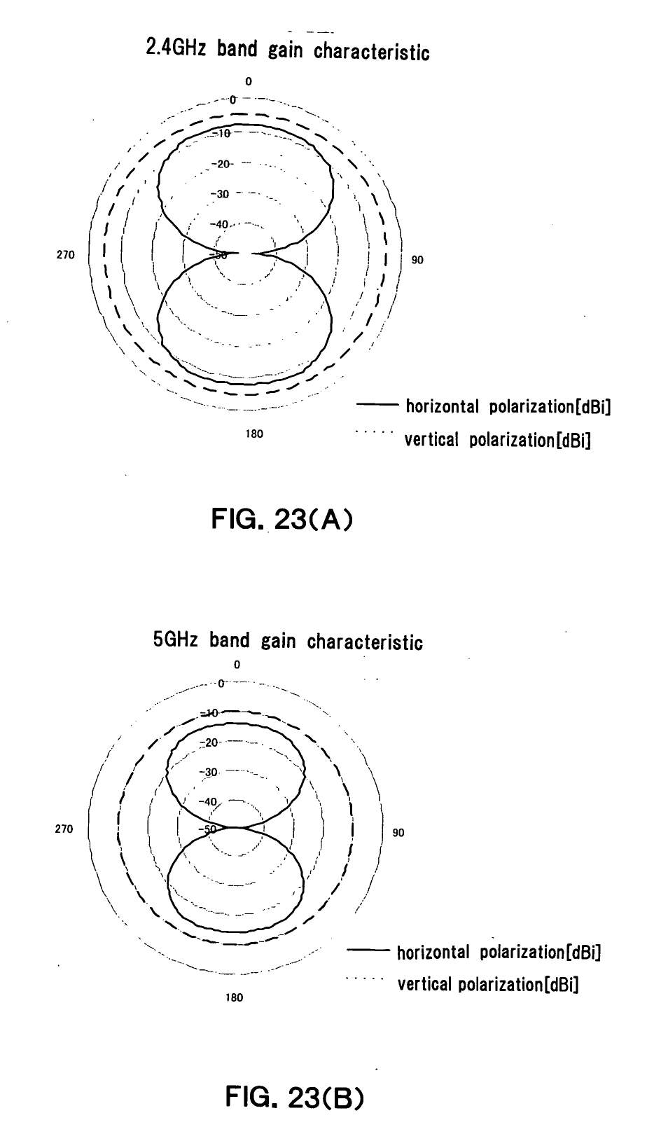

The best condition of the phase adjustment is established in a delicate positional relation between the feeding wire and the emission patterns 101. Accordingly it is inappropriate for the mass-production to provide the phase adjustment by means of the coaxial cable as shown in FIG. 16 (B). On the contrary it is appropriate for the mass-production of the antenna with good characteristics to provide the phase adjustment by means of the feeding pattern 183 having the best pattern arrangement defined beforehand as shown in FIG. 21. FIG. 23 shows measured gain characteristics about the antenna shown in FIG. 16(B). The planar broadband antenna in the embodiment has the broad bandwidth and vertical polarization or main polarization indicates characteristics similar to non-directivity. The characteristics demonstrating capability to receive radio waves from every direction is ideal to be used for the mobile information terminal.

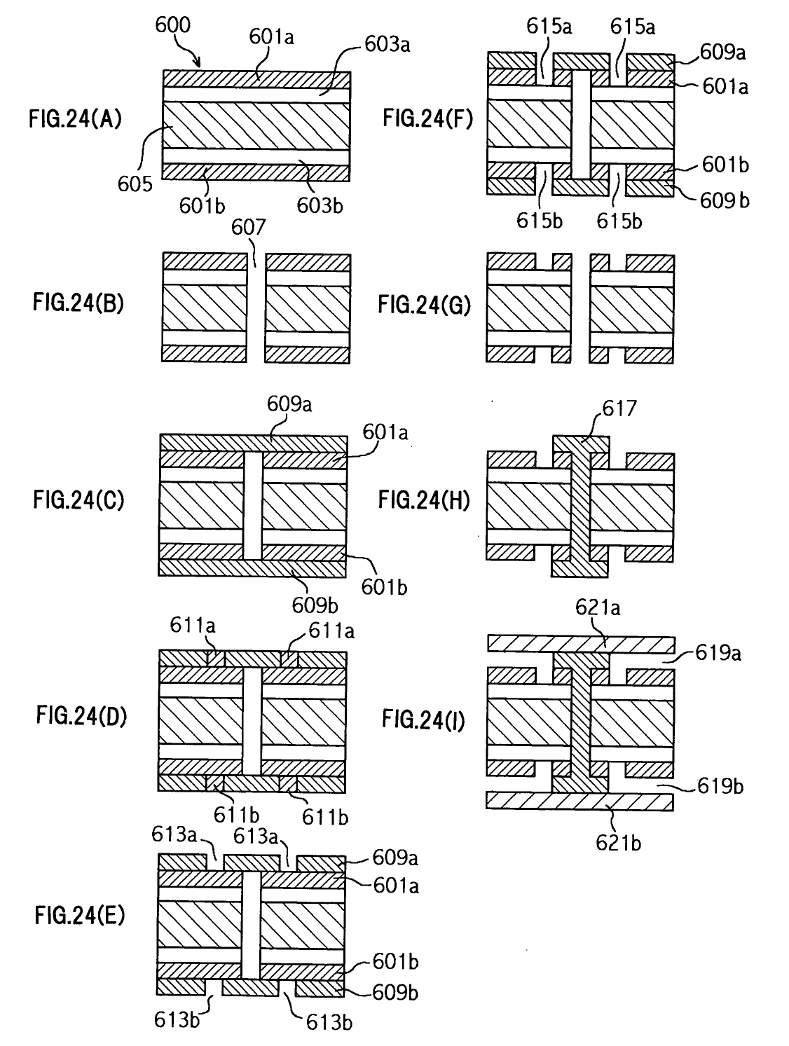

FIG. 24 shows a manufacturing process of the planar broadband inverted F-type antenna. FIG. 24 (A) shows cross-sectional view of a FPC 600 provided with copper foil layers 601a, 601b adhering to a base film 605 with adhesion 603a, 603b. The base film 605 is the PET having 75 micron in thickness. The polyimide is applicable as materials of the base film. The adhesion 603a and 603b is used to bond the base film 605 and the copper foil layers 601a, 601b together and has 25 micron in thickness. The copper foil layer 601a and 601b have 35 micron in thickness respectively. A single sided pattern enables the antenna to use a FPC without the copper foil layer 601b at the obverse side. This type of the FPC 600, specifying the materials of the base film and area of the copper foil layer 601a, 601b, can be obtained from many manufacturers at home and abroad.

A through-hole 607 having 0.2 mm-0.3 mm in diameter is drilled to penetrate from the copper foil layer 601a to the copper foil layer 601b at a position to form the silver through-hole in FIG. 24(B). Photoresist 609a and 609b are applied on the copper layer 601a, 601b respectively in FIG. 24(C). The copper foil layer 601a and 601b are exposed with the X-ray through a mask provided with an antenna pattern to make an exposed portion changed to soluble state against washing liquid (positive type) A negative type photoresist is applicable to make non-exposed portion changed to soluble state against the washing liquid.

The exposed photoresist is developed followed by removing the exposed portion 611a, 611b in the washing liquid, and a pattern 613a and a pattern 613b of photoresist 609a and 609b are formed on the copper foil layer 601a and 601b respectively in FIG. 24(E). The pattern 613a and the pattern 613b are patterns to be removed from the copper foil layer 601a and 601b respectively. A type of the photoresist, the washing liquid, and radiation can be selected from a well known combination thereof. The copper foil layer 601a and 601b are etched through the photoresist pattern 613a and 613b, forming copper layer pattern 615a and 615b in FIG. 24 (F).

The photoresist 609a and 609b are removed entirely by using other washing liquid in FIG. 24(G). All patterns in the copper foil layers are formed other than the silver through-hole in FIG. 24(G). The silver through-hole is formed at the through-hole 607 by means of silk-printing in FIG. 24 (H). A squeegee is used to conduct the silk-printing with a screen made of nylon or tetron (both are registered trademark) where portions which let the silk pass and portions which do not let the silk pass are formed. A copper through-hole formed by plating the hole with the copper to form the through-hole in the PET is applicable, however the silk through-hole 617 provided by the silk-printing is preferable since the PET is affected from heat or chemical and the silk-printing has no such behavior. The copper foil layers and the silver through-hole are covered with a cover film 621a and 621b with adhesion 619a, 619b in FIG. 24(I). The cover film 619a, 619b are the PET films having 25 micron in thickness. The cover film having the positional aperture to the ground point or the feeding point formed by the other process is positioned and adhered to the copper foil layer.

The planar broadband inverted F-type antenna of the present invention is usable in connection with the transmitter or the receiver of the information terminal, such as the notebook personal computer, the PDA, or the cellular phone, which are equipped with a processor and a wireless LAN system controlled by the processor. Especially the antenna of the present invention having the characteristics of the broad bandwidth in addition to the small shape and non-directivity is usable for the mobile information terminal carried in crossing the boarder. Although the present invention has so far been described with reference to particular embodiments, the scope of the present invention is not limited to these embodiments. It is apparent that the present invention can be employed in any known structure to which the present invention provides effect.

1. A planar broadband inverted F-type antenna, having a conductive layer pattern formed on a surface of a dielectric layer, being used for a 5.0 GHz band and a 2.4 GHz band, and being connectable with a feeding wire, said conductive layer pattern comprising;
an electrical ground having a ground point connectable to a ground line of the feeding wire, and being formed on an obverse side of the dielectric layer;
a first element having emission patterns between six or more and nine or less, each pattern being adaptable to the 5.0 GHz band, each pattern having a length varying from each other, and said first element being formed on the obverse side of the dielectric layer;
a second element having a feeding point connectable to a voltage line of the feeding wire, connecting each emission pattern of said first element to said electrical ground, and being formed on the obverse side of the dielectric layer;
a third element having an emission pattern adaptable to the 2.4 GHz band at lambda/4 (where lambda is a wavelength), being connected to said second element, and being formed on the obverse side of the dielectric layer; and
a feeding pattern having a feeding terminal, being connected to the feeding point of said second element, and being formed on a reverse side of the dielectric layer;
wherein said feeding pattern includes a parallel wiring component to the emission patterns of said first element, said feeding pattern is positioned to overlap a vertical projection with at least one of the emission patterns of said first element so that a phase adjustment is provided to decrease a voltage standing wave ratio.

2. A planar broadband inverted F-type antenna, having a pattern formed by etching a conductive foil laminated on an obverse side and a reverse side of a base film, being used for a first frequency band, and being connectable with a feeding wire, comprising;
an electrical ground having a ground point connectable to a ground line of the feeding wire, and being formed on the obverse side of the base film;
a first element having a plurality of emission patterns, each emission pattern being adaptable to the first frequency band, each pattern having a length varying from each other, and said first element being formed on the obverse side of the base film;
a second element connecting each emission pattern of said first element to said electrical ground, and being formed on the obverse side of the base film; and
a feeding pattern having a feeding terminal connectable to a voltage line of the feeding wire, being connected to said second element, and being formed on the reverse side of the base film,
wherein said feeding pattern includes a parallel wiring component to the emission patterns of said first element, said feeding pattern is positioned to overlap a vertical projection with at least one of the emission patterns of said first element so that a phase adjustment is provided to decrease a voltage standing wave ratio.

3. A planar broadband inverted F-type antenna according to claim 2, wherein the base film is made of polyethylene terephthalate, and said feeding pattern and said second element are connected with each other bay way of a silver through-hole.

4. A planar broadband inverted F-type antenna according to claim 2, wherein the base film is made of polyethylene terephthalate, said antenna has a silver through-hole connected to the feeding pattern at one end and connected to the voltage line at the other end on the obverse side of the base film, and said feeding pattern is positioned by observing a VSWR wave form with a network analyzer.

5. An information terminal having a wireless LAN, comprising;
a processor;
a receiver controlled by said processor; and
an antenna;
wherein said antenna is set force in any one of claims 1-4.
